(19) United States
(12) Patent Application Publication
(10) Pub. No.: US 2015/0278499 A1
(43) Pub. Date: Oct. 1, 2015

(54) Motion-Triggered Biometric System for Access Control

(71) Applicant: Yevgeny Levitov, San Antonio, TX (US)

(72) Inventor: Yevgeny Levitov, San Antonio, TX (US)

(21) Appl. No.: 14/547,135

(22) Filed: Nov. 19, 2014

Related U.S. Application Data
(60) Provisional application No. 61/907,383, filed on Nov. 21, 2013.

(51) Int. Cl. G06F 21/32; H04N 5/33; G06K 9/00

(52) U.S. Cl. CPC G06F 21/32; G06K 9/00228; H04N 5/33; G06K 9/00604

(57) ABSTRACT

A system and method for regulating access to a computing device, wherein a motion detector detects motion near the computing device and triggers an imaging device to receive an image, which is then analyzed to identify any people in the image. If at least one person in the image is not an authorized user, the computing device is locked or disconnected from the Internet.

### CROSS-REFERENCE TO RELATED APPLICATIONS

The present application takes priority from Provisional Application No. 61/907,383, filed Nov. 21, 2013, which is herein incorporated by reference.

### BACKGROUND

Restricting access to a computer system to authorized users is an important and serious problem. Passwords are most commonly used, but they are highly vulnerable to hacking. Physical objects such as cards or keys can be lost or stolen and used by an unauthorized user. For these reasons, many computers, smartphones, and similar devices now use biometrics to identify authorized users. Such biometric access control devices may use fingerprints, face or voice identification, or even heartbeat.

One other advantage of biometric access control systems is that they are more invisible to the user than a password or key. Instead of entering a complicated password or using a key, the user's face or any other biometric parameter may be identified without the need for the user to take any sort of action.

This renders biometric access control systems advantageous in highly sensitive applications where security is paramount. If a user has to lock a computer every time they step away from the machine, and then unlock it every time they come back, it is highly likely that they will leave the computer unlocked and unattended at least once. If the locking and unlocking happens automatically without any need for intervention by the user, the security of the system will be much improved.

U.S. Pat. No. 6,111,517 to Atick et al. describes a system where the biometric identification is continuous—the computer continuously identifies the user's face as the user uses the computer, and locks the computer when the user steps away from the machine or is replaced by a different user. While this is optimal for maintaining proper computer security, the reason that such systems are not yet in wider use is that they are very resource-intensive. Face recognition is a complex and difficult task, involving a lot of complicated calculations; other biometric recognition systems, such as iris recognition, are equally difficult. The Atick system has to continuously monitor the camera's field of vision to be able to detect unauthorized users. This takes up computer resources that could otherwise be used for the computer's normal applications. Also, the resource-intensive nature of the system means that it cannot be used on less-powerful computing devices such as smartphones, or built into a video camera.

A need therefore exists for a continuous biometric identification system that is less resource-intensive than prior art systems and that does not require to be running continuously in order to be effective.

### SUMMARY OF THE INVENTION

Therefore, the object of the present invention is to provide a system and method for automatically locking or unlocking a computer system, smartphone, tablet, or any other computing device, by performing a biometric identification of any people in front of the camera only when motion is detected in front of the camera.

Another object of the present invention is to provide a system for continuous biometric user identification that uses minimal computer resources to run.

Another object of the present invention is to provide a system for continuous biometric user identification that is only triggered when motion is detected in the field of view.

Another object of the present invention is to provide a method of electronic authentication of a document using biometrics.

For purposes of the present disclosure, a “computing device” is any computer, netbook, smartphone, tablet, e-reading device, mobile terminal, or other device that may require access to be limited to authorized users.

The system of the present invention preferably comprises an image capturing device capable of capturing images usable for biometric analysis, a motion detector, and a biometric analyzer capable of identifying a person from an image captured by the image capturing device, where the motion detector is configured to trigger the image capturing device to capture an image when the motion detector detects motion, and wherein the biometric analyzer is configured to identify any persons in the image.

The image capturing device is preferably a camera—a built-in camera of a laptop or smartphone or tablet, or a separate camera connected to the computing device by a cable or wirelessly. The biometric analyzer is preferably a face recognition module. The face recognition module is preferably implemented in the computing device's memory and CPU, but may also be a part of the separate camera connected to the computing device by a cable or wirelessly.

In an alternate embodiment, the image capturing device is a retina scanner, and the biometric analyzer is a retina-scan analyzer. Similarly, these may be part of a separate device connected to the computing device by a cable or wirelessly, or may be part of the computing device itself.

In an embodiment, said embodiment using the facial-recognition embodiment of the present invention, the system further comprises an infrared illumination device and an infrared camera, and the biometric analyzer uses both the images from the infrared camera and from the camera to recognize any faces in the images.

The computing device is preferably configured to lock, or disconnect from the Internet, whenever the biometric analyzer detects that at least one of the people in front of the computing device is not an authorized user. The computing device unlocks, or connects to the Internet, whenever the biometric analyzer detects that all of the people in front of the computing device are authorized users.

In the embodiment where the image capturing device, motion detector, and biometric analyzer are all part of a separate device connected to the computing device by a wired or wireless connection, the computing device may also be configured to lock when the connection is broken.

The method of the present invention preferably comprises the following steps: storing a biometric representation for at least one authorized user; detecting motion near the computing device; triggering an image capturing device to receive an image when motion is detected; and analyzing the image to identify any people in the image as authorized or unauthorized users.

If all the people in the image are authorized users, the computing device is unlocked, or remains unlocked. If at least one person in the image is not an authorized user, the computing device is locked, or remains locked. The computing device may also be disconnected from the Internet if at least one person in the image is not an authorized user, and allowed to connect to the Internet if all the people in the image are authorized users.

The biometric representations of authorized users may be stored in the computing device (or on a separate device) ahead of time, or may be recorded at the start of the use session.

In an embodiment, the image capturing device may also be triggered to capture another image a predetermined time interval after motion is detected, and the image may be analyzed to identify any people in the image as authorized or unauthorized users. These steps may be performed repeatedly at regular intervals throughout the use session while the computing device is unlocked.

The biometric analysis may be facial analysis, retinal scan analysis, or any other analysis that is capable of identifying a person from an image.

### LIST OF FIGURES

FIG. 1 shows an embodiment of the system of the present invention.

FIG. 2 shows a flowchart for an embodiment of the method of the present invention.

FIG. 3A shows a screenshot from the preferred embodiment of the system of the present invention.

FIG. 3B shows a screenshot from the preferred embodiment of the system of the present invention.

FIG. 3C shows a screenshot from the preferred embodiment of the system of the present invention.

FIG. 4A shows a screenshot from the preferred embodiment of the system of the present invention.

FIG. 4B shows a screenshot from the preferred embodiment of the system of the present invention.

FIG. 4C shows a screenshot from the preferred embodiment of the system of the present invention.

FIG. 5A shows a screenshot from the preferred embodiment of the system of the present invention.

FIG. 5B shows a screenshot from the preferred embodiment of the system of the present invention.

FIG. 5C shows a screenshot from the preferred embodiment of the system of the present invention.

### DETAILED DESCRIPTION OF THE PREFERRED EMBODIMENT

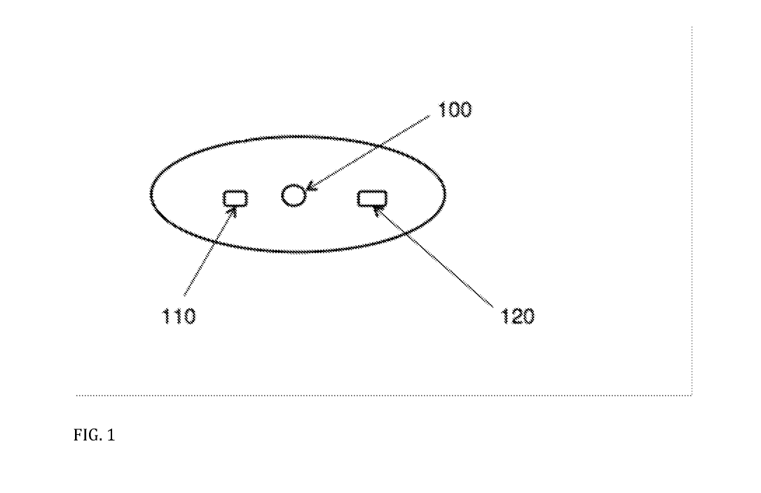

In its preferred embodiment, the system of the present invention comprises an imaging device 100, a motion detection module 110, and a biometric identification module 120, as shown in FIG. 1. The imaging device is preferably a camera, but may also be a retina scanning device or any other imaging device that can be used to acquire images used for biometric identification, and to acquire them passively without active user involvement. The motion detection module and the biometric identification module can be installed on the computer system or other entity that needs to be secured, a different computer system, or within the imaging device itself. The motion detection module (whether a dedicated module or motion detection software) detects any motion in front of the computing device, and may comprise a dedicated motion sensor such as an infrared sensor or infrared sensing software, or may use the imaging device itself. If no motion is detected, the biometric identification module is inactive and uses no resources, and the computer system stays locked, or unlocked, as the case may be. If motion is detected in front of the imaging device, the imaging device is triggered to receive an image, and the biometric identification module is activated and identifies any person or persons in the image. If all of the persons are authorized users, the system is unlocked. If at least one person is an unauthorized user, the system is locked.

The biometric identification module is preferably a facial identification module, and the imaging device is preferably a camera used to receive facial images. In alternate embodiment, a retina scanner is used. Other biometric identification modules that can be used at a distance may also be used.

Facial identification is more difficult in field conditions, such as outdoors or on a factory floor, than it is in normal office or home conditions, due to differences in lighting. In an embodiment, the system of the present invention comprises a second camera used to receive infrared images and an infrared emitting device to provide infrared illumination.

The system of the present invention may be implemented as software, using the computing device's built-in camera for both the motion detection and the biometric user recognition; or it may be implemented partially or entirely as hardware, including its own dedicated camera, an optional infrared camera, and dedicated modules for motion detection and biometrics built into the camera. In an embodiment, the system of the present invention is implemented as a separate device that comprises all the elements of the system of the present invention—the camera, the motion detection module, and the biometric identification module, and a processor that allows these elements to function. In that embodiment, the system of the present invention is connected to a computing device using a USB port; if the USB connection is broken, the computing device locks automatically.

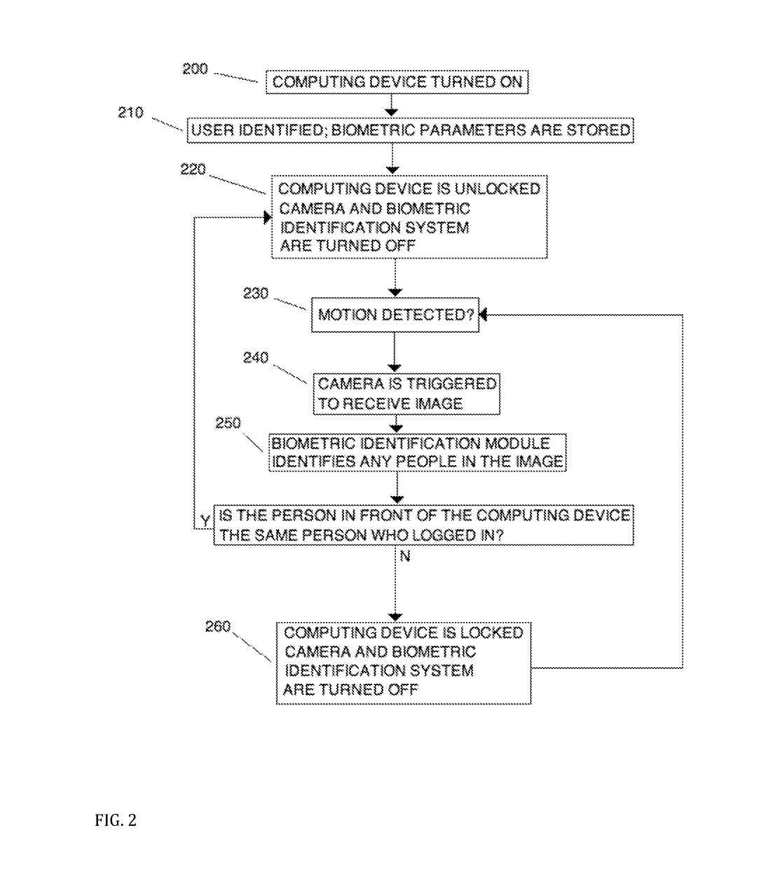

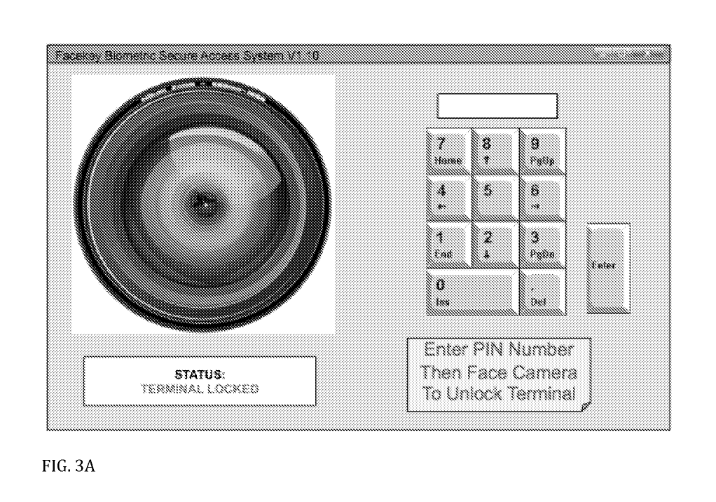

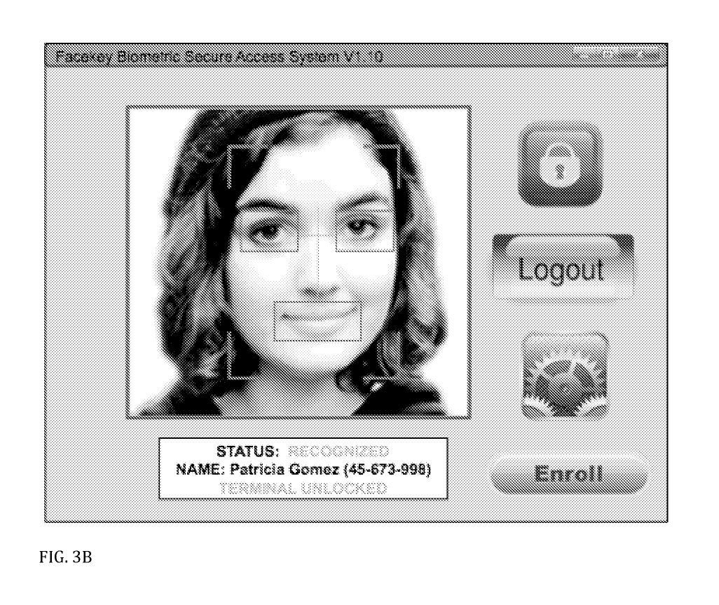

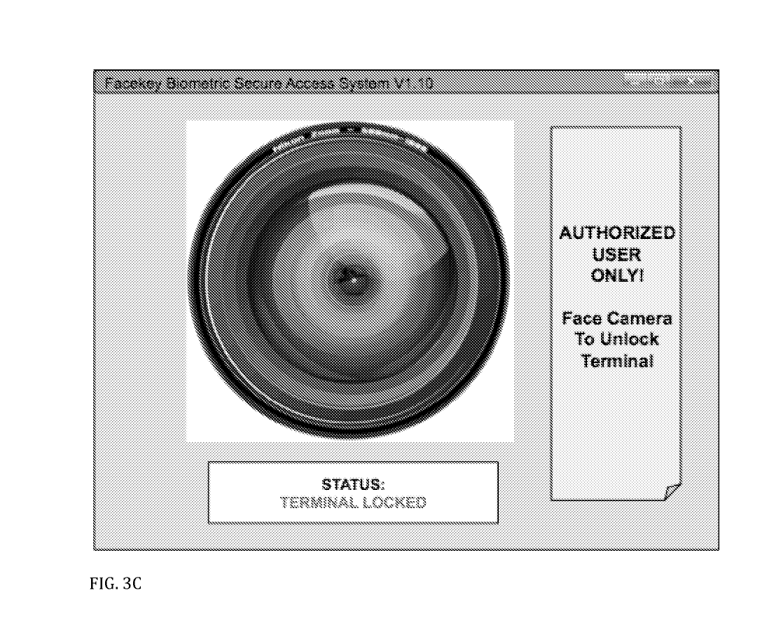

FIG. 2 shows a diagram of the preferred embodiment of the method of the present invention. Initially, the user turns on the computing device 200. FIG. 3A shows a screenshot of the login screen that the user sees when the computing device is turned on, in an embodiment of the present invention. When the computing device is first turned on, the user is identified by means of biometrics 210 and the user's biometric parameters are stored in the computing device or elsewhere. FIG. 3B shows a screenshot of the identification screen showing the user as RECOGNIZED and the terminal as UNLOCKED. The camera and biometric identification system are then turned off, and the computing device stays unlocked 220 until motion is detected in front of the camera, or the selected time interval is reached. The user can then use the computing device without the biometric identification system putting an additional load on its resources.

When motion is detected in front of the camera 230, the camera and biometric identification module are activated. The camera is triggered to receive at least one image 240, and the biometric identification module is used to identify any people in the image 250. If the only person in the image is the user whose biometric parameters are stored in the computing device (i.e. the same person as the person who originally logged into the computer), the computing device remains unlocked. If any other person is detected in the image, the computing device is locked 260. The biometric identification module is then turned off. The motion detector stays turned on. FIG. 3C shows a screenshot of the locked screen of the preferred embodiment of the present invention.

If the computing device is locked 260, the system waits for motion to be detected in front of the camera. When that happens, the system triggers the camera to receive at least one image, and the biometric identification module is used to identify any people in the image. If the only person in the image is the user who originally logged into the computer, the computing device is unlocked. If any other people are present in the image, the computing device stays locked.

When the user logs off from the computing device, the computing device is locked and the system waits for the next user to log in.

In other embodiments of the method, the computing device may be disconnected from the Internet when it is locked, or may remain unlocked but may be disconnected from the Internet when any person other than the authorized user is present in front of the camera.

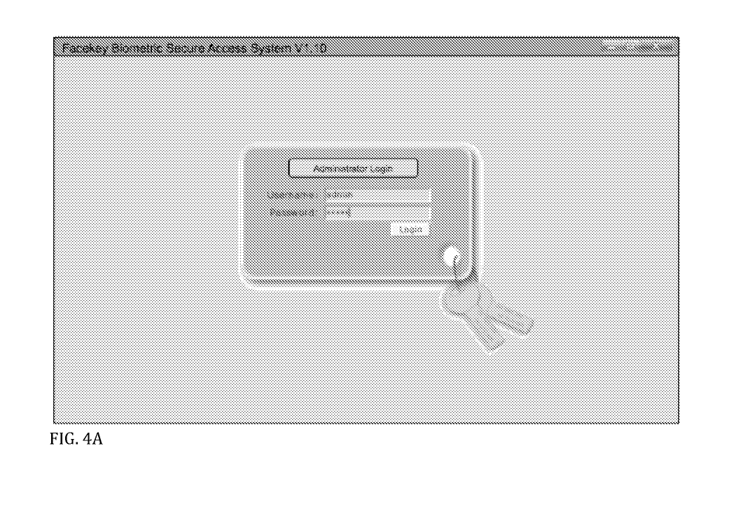

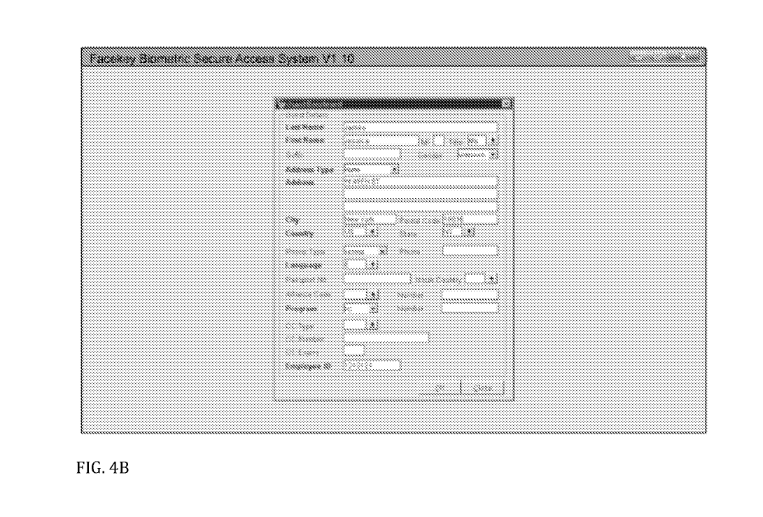

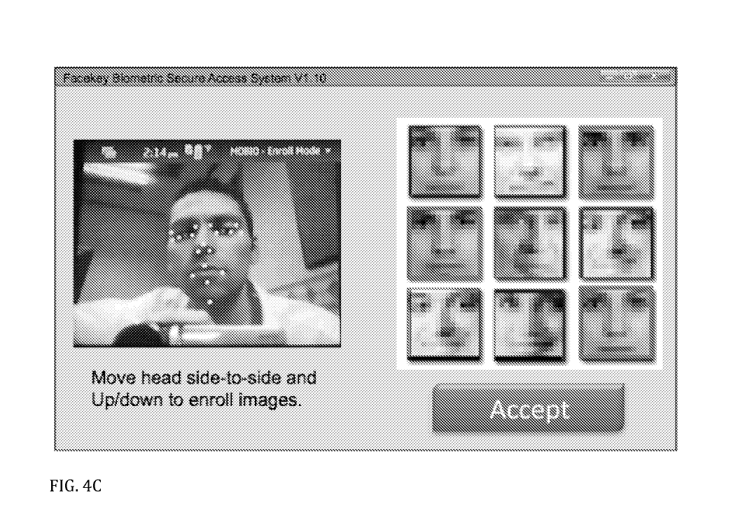

FIGS. 4A-4C show screenshots of the process used to enroll a new user into the system in the preferred embodiment of the present invention. FIG. 4A shows a screen where the administrator enters their username and password prior to getting access to the system. FIG. 4B shows a screen where the administrator enters a new user's information and any personal details required to create an account. FIG. 4C shows a screen where the new user's facial images are captured and saved. As is shown in the screenshot, the user is encouraged to move their head and face from side to side and up/down and to make different facial expressions, and multiple images are preferably taken. Once the desired images are captured and saved, the administrator clicks the “Accept” button to save the images into the authorized user facial library. This facial library is preferably stored on a server connected to the computing device through a secure wired or wireless connection, but may also be stored on the computing device itself.

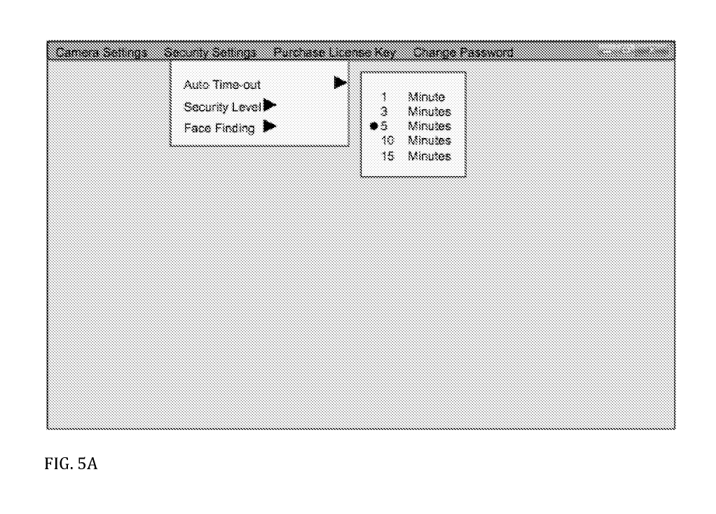

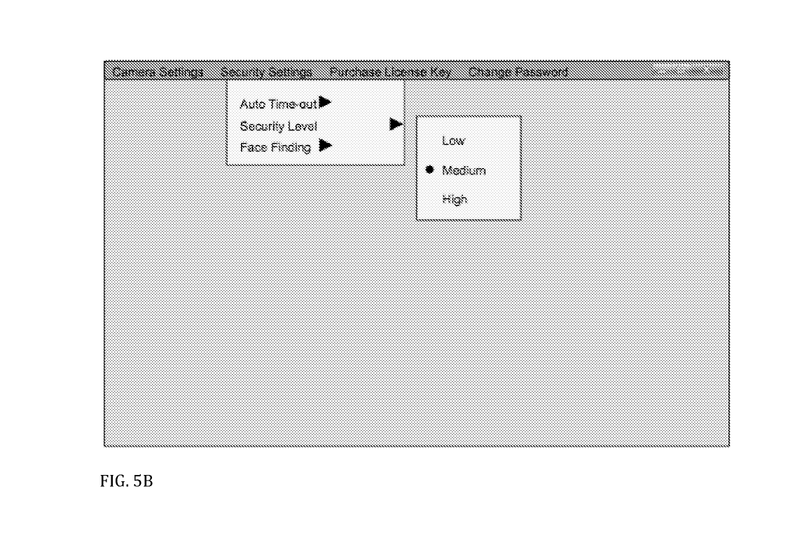

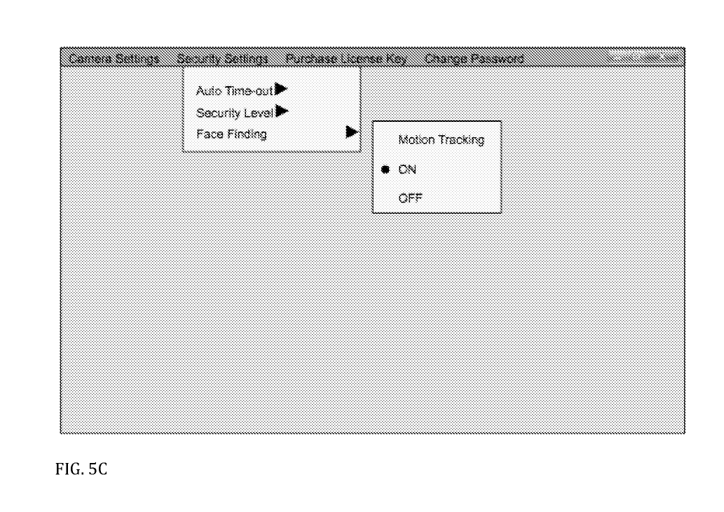

FIGS. 5A-5C show the settings screen in the preferred embodiment of the present invention. A user can set an “auto time-out” period when the computing device automatically locks after a period of inactivity, as shown in FIG. 5A. FIG. 5B shows the security level setting—a user can set a Low, Medium, or High security level. The higher the security level, the more detailed the face-recognition process; this reduces the false-acceptance rate (errors where an unauthorized user is misidentified as an authorized user and granted access), but increases the false-rejection rate (errors where an authorized user is misidentified as an unauthorized user and denied access). FIG. 5C shows the motion tracking screen. A user can turn off motion tracking if motion-detection is not needed for a particular application or time period.

The system and method of the present invention may be implemented on any computing device to which a camera may be connected, or which comprise a camera or any other imaging device. Such computing devices include smartphones, tablets, laptops, netbooks, e-reading devices, desktops, workstations, terminals, and any other devices that require secure access control.

Exemplary embodiments are described above. It will be understood that the invention is not limited to those exemplary embodiment, but is limited only by the appended claims.

1. A system for regulating access to a computing device, comprising:
an image capturing device capable of capturing images usable for biometric analysis;
a motion detector;
a biometric analyzer capable of identifying a person from an image captured by the image capturing device;
wherein the motion detector is configured to trigger the image capturing device to capture an image when the motion detector detects motion;
and wherein the biometric analyzer is configured to identify any persons in the image.

2. The system of claim 1, wherein the image capturing device is a retina scanner.

3. The system of claim 2, wherein the biometric analyzer is a retina-scan analyzer.

4. The system of claim 1, wherein the image capturing device is a camera.

5. The system of claim 4, wherein the biometric analyzer is a face recognition module.

6. The system of claim 4, wherein the camera is a built-in camera of the computing device.

7. The system of claim 1, wherein the biometric analyzer is the CPU of the computing device, and the motion detector is the built-in camera of the computing device.

8. The system of claim 5, further comprising:
an infrared illumination device;
an infrared camera;
wherein the biometric analyzer is configured to use images from the infrared camera as well as from the camera.

9. The system of claim 1, further comprising:
a memory storing a biometric representation of at least one authorized user;
wherein the computing device is locked whenever the biometric analyzer detects that at least one of the people in front of the computing device is not an authorized user;
wherein the computing device is unlocked whenever the biometric analyzer detects that all of the people in front of the computing device are authorized users.

10. The system of claim 1, further comprising:
a memory storing a biometric representation of at least one authorized user;
wherein the computing device is prevented from accessing the Internet whenever the biometric analyzer detects that at least one of the people in front of the computing device is not an authorized user;
wherein the computing device is enabled to access the Internet whenever the biometric analyzer detects that all of the people in front of the computing device are authorized users.

11. The system of claim 10, wherein the memory, the image capturing device, the motion detector, and the biometric analyzer are located in a housing connected to a computing device by a connection in one of the following group: a wired connection, a wireless connection.

12. The system of claim 11, wherein the computing device is configured to lock when the connection is broken.

13. A method for regulating access to a computing device, comprising:
storing a biometric representation for at least one authorized user;
detecting motion near the computing device;
triggering an image capturing device to capture an image when motion is detected;
analyzing the image to identify any people in the image;
determining whether each person in the image is an authorized user.

14. The method of claim 13, further comprising:
if each person in the image is an authorized user, and the computing device is locked, unlocking the computing device;
if each person in the image is an authorized user, and the computing device is unlocked, leaving the computing device unlocked;
if at least one person in the image is not an authorized user, and the computing device is locked, leaving the computing device locked;
if at least one person in the image is not an authorized user, and the computing device is unlocked, locking the computing device.

15. The method of claim 13, further comprising:
if each person in the image is an authorized user, and the computing device is disconnected from the Internet, connecting the computing device to the Internet;
if each person in the image is an authorized user, and the computing device is connected to the Internet, leaving the computing device connected to the Internet;
if at least one person in the image is not an authorized user, and the computing device is disconnected from the Internet, leaving the computing device disconnected from the Internet;
if at least one person in the image is not an authorized user, and the computing device is connected to the Internet, disconnecting the computing device from the Internet.

16. The method of claim 13, further comprising the following steps performed prior to the storing step:
starting the computing device;
recording a biometric representation for a first authorized user;
wherein the determining step comprises determining whether any of the people in the picture are the first authorized user.

17. The method of claim 13, wherein the biometric representation for at least one authorized user is stored on a second computing device.

18. The method of claim 13, further comprising:
after a predetermined time interval, triggering the image capturing device to receive a second image;
analyzing the second image to identify any people in the second image;
determining whether each person in the second image is an authorized user.

19. The method of claim 18, where the additional steps are performed repeatedly at regular intervals.

20. The method of claim 18, where the additional steps are only performed when the computing device is unlocked.

21. The method of claim 13, wherein the analyzing step is one of the following group: facial analysis, retinal scan analysis.
